(19) United States
(12) Patent Application Publication
(10) Pub. No.: US 2021/0352264 A1
(43) Pub. Date: Nov. 11, 2021

(54) INTEGRATED STEREO IMAGE DISPLAY DEVICE

(71) Applicant: Lixel Inc., Taipei City (TW)

(72) Inventors: CHUN-HSIANG YANG, Hsinchu City (TW); CHIH-HUNG TING, New Taipei City (TW); KAI-CHIEH CHANG, Kaohsiung City (TW); JUI-YI WU, Miaoli County (TW); HSIN-YOU HOU, New Taipei City (TW)

(21) Appl. No.: 16/868,541

(22) Filed: May 7, 2020

(51) Int. Cl. H04N 13/302; G09G 3/00

(52) U.S. Cl. CPC H04N 13/302; G09G 2320/0233; G09G 3/002

(57) ABSTRACT

An integrated stereo image display device includes a display unit, a lens array layer, and a gradient transmittance mask. The gradient transmittance mask includes a plurality of mask units, and the mask units have a gradient transmittance. An un-reconstructed image displayed by a display surface of the display unit can be reorganized and reconstructed as an integrated image to form a stereo image by the lens array layer. The gradient transmittance mask is able to provide even brightness distribution after imaging. As a result, the image would be without a grid-like appearance, and the quality of the viewing experience for a user is therefore improved.

### FIELD OF THE DISCLOSURE

The present disclosure relates to a display device, and more particularly to an integrated stereo image display device.

### BACKGROUND OF THE DISCLOSURE

Conventional stereo image display devices mainly employ a binocular vision imaging technology. Generally, naked eye stereo image display devices allow viewers to view images from a position directly in front of the device, and an image depth of the image display devices cannot be too far away from a display surface. However, in some situations, such as aerial terrain models, architectural models, medical 3D training, etc., when the image display devices are placed horizontally, the viewers may view the image display device from a naturally oblique viewing angle. However, a natural image cannot be provided to the viewers with the conventional stereo image display technology when the stereo image is viewed from an oblique angle. Furthermore, the stereo image of the general stereo image display device can only provide a visual stimulation in one direction, i.e., either with the image projecting out or sinking in. Therefore, the conventional stereo image display devices cannot provide an image that appears to break free of the confines of the plane and float in mid-air. In addition, the conventional integrated stereo image display devices can provide uneven brightness distribution after imaging, which may cause a grid-like appearance to be perceived by the viewer, thus negatively affecting the viewing experience.

### SUMMARY OF THE DISCLOSURE

In response to the above-referenced technical inadequacies, the present disclosure provides an integrated stereo image display device to provide an effect of a floating display when displaying stereo images. As a result, viewers can view stereo images from an oblique angle and a position directly in front of the device. In addition, the integrated stereo image display device is able to provide an even brightness distribution after imaging. As a result, the image would be without a grid-like appearance, and the quality of the viewing experience for a user is therefore improved.

In one aspect, the present disclosure provides an integrated stereo image display device. The integrated stereo image display device includes a display unit, a lens array layer, and a gradient transmittance mask. The display unit includes a display surface and an image processing unit. The lens array layer is disposed adjacent to the display surface of the display unit, and the lens array layer includes a plurality of lenses. The gradient transmittance mask includes a plurality of mask units, in which the mask units have a gradient transmittance, and an unstructured image displayed by the display surface is able to be reorganized by the lens array layer, and then be recombined into an integrated image to form a stereo image. The gradient transmittance mask is able to provide even brightness distribution after imaging.

In another aspect, the present disclosure provides an integrated stereo image display device. The integrated stereo image display device includes a display unit and a lens array layer. The display unit includes a display surface and an image processing unit. The lens array layer is disposed adjacent to a display surface of the display unit, in which the lens array layer includes a plurality of lenses, and a light absorbing substance is added to the material of the lens so that the transmittance of the lens is inversely proportional to the thickness of the lens with the function of gradual transmission. An unstructured image displayed by the display surface is able to be reorganized by the lens array layer, and be recombined into an integrated image to form a stereo image. The brightness after imaging is uniformly distributed by a light absorbing substance.

In yet another aspect, the present disclosure provides an integrated stereo image display device. The integrated stereo image display device includes a display unit, a pinhole array layer, and a gradient transmittance mask. The display unit includes a display surface and an image processing unit. The pinhole array layer is disposed adjacent to the display surface of the display unit, in which the pinhole array layer includes a main body and a plurality of pinholes. The pinholes are disposed on the main body, and the pinholes pass through two opposite sides of the main body. The gradient transmittance mask includes a plurality of mask units, in which the mask units have a gradient transmittance, and an unstructured image displayed by the display surface is able to be reorganized by the pinhole array layer, and be recombined into an integrated image to form a stereo image. The gradient transmittance mask is able to provide even brightness distribution after imaging.

In still yet another aspect, the present disclosure provides an integrated stereo image display device including a display unit and a gradient transmittance mask. The display unit includes a liquid crystal display (LCD) panel, a backlight module, and an image processing unit. The LCD panel includes a display surface, and the LCD panel is able to turn on pixels that are needed and turn off pixels that are unneeded. The backlight module includes a plurality of light sources. The gradient transmittance mask includes a plurality of mask units, in which the mask units have the gradual transmittance, and an unstructured image displayed by the display surface is able to be reorganized by the light sources and the LCD panel, and then be recombined into an integrated image to form a stereo image. The gradient transmittance mask is able to provide even brightness distribution after imaging.

Therefore, the present disclosure can provide the floating display effect so that the viewers can view the stereo image from an oblique angle and a position directly in front of the device. In addition, the present disclosure provides the gradient transmittance mask including a plurality of mask units. The mask units have a gradient transmittance so that the brightness of the image can be evenly distributed after imaging without a grid-like appearance as a result of the mask units having different transmittance.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic view of an integrated stereo image display device according to a first embodiment of the present disclosure.

FIG. 2 is an exploded view of the integrated stereo image display device according to the first embodiment of the present disclosure.

FIG. 3 is a schematic view of a relative arrangement of lens arrays according to the present disclosure.

FIG. 4 shows a schematic view of a staggered arrangement of lens arrays according to the present disclosure.

FIG. 5 is a schematic view showing the focusing of a single lens according to embodiments of the present disclosure.

FIG. 6 is a schematic view of an integrated stereo image display device according to a second embodiment of the present disclosure.

FIG. 7 is a schematic view of an integrated stereo image display device according to a third embodiment of the present disclosure.

FIG. 8 is a schematic view of an integrated stereo image display device according to a fourth embodiment of the present disclosure.

FIG. 9 is a schematic view of an integrated stereo image display device according to a fifth embodiment of the present disclosure.

FIG. 10 is a schematic view of an integrated stereo image display device according to a sixth embodiment of the present disclosure.

FIG. 11 is a schematic view of an integrated stereo image display device according to a seventh embodiment of the present disclosure.

FIG. 12 is a schematic view of a gradient transmittance mask according to another embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

The present disclosure provides an integrated stereo image display device, which can be used in many industries such as optoelectronics, medical, military, exhibition, display, education, entertainment, and consumer electronics. The integrated stereo image display device can be used in active or passive image display device, but the present disclosure is not limited thereto.

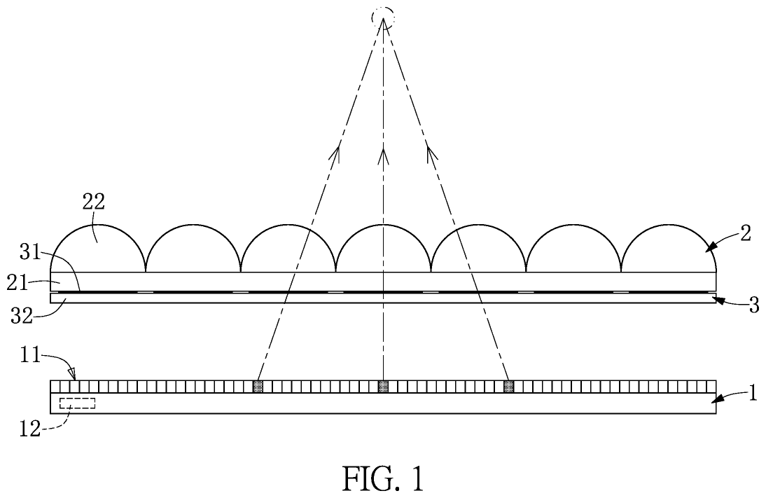

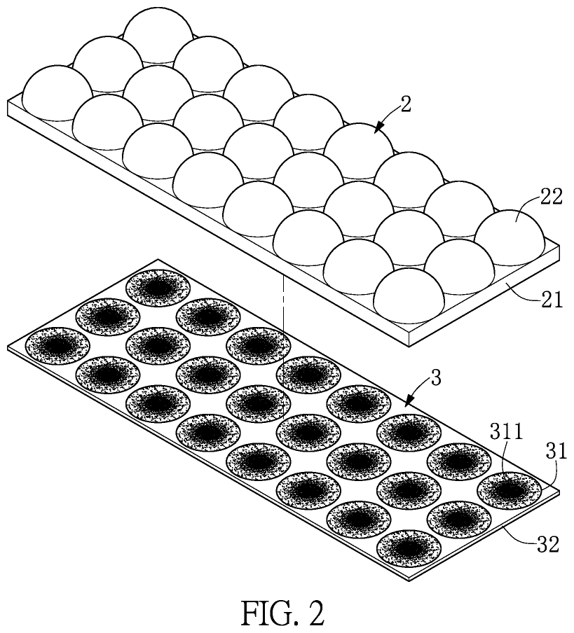

Referring to FIG. 1 and FIG. 2, the integrated stereo image display device includes a display unit 1, a lens array layer 2, and a gradient transmittance mask 3. The integrated stereo image display device can change stereo images that are perceived from a certain angle of view, so that the stereo images can be viewed by a viewer from different angles of view.

The display unit 1 can be a general flat display unit, and the display unit 1 includes a display surface 11 that can display images. The lens array layer 2 is disposed adjacent to the display surface 11 of the display unit 1, that is, the lens array layer 2 can be above the display unit 1. The lens array layer 2 can be arranged in contact with the display surface 11 of the display unit 1, and the lens array layer 2 and the display surface 11 of the display unit 1 may also be spaced apart from each other, or an intermediate layer can be disposed between the display surface 11 of the display unit 1 and the lens array layer 2.

The display unit 1 can be disposed as a bottom layer, and is configured to display a planar image that has not been reproduced by light. The planar image can be redistributed and combined by the lens array layer 2 to display a reconstructed 3D stereo image. The display unit 1 of the first layer only needs to display a target image, and accordingly, the display unit 1 can be any hardware structure, including a mobile phone, a tablet, or a flat screen. The type and the configuration of the display unit 1 are not limited thereto, and the display unit 1 can also be a self-illuminated display unit.

The lens array layer 2 can be disposed as an uppermost layer, and the lens array layer 2 is capable of adjusting the light field. The lens array layer 2 can modulate a light angle of a stereo image so that the planar images that have not been reorganized can be redistributed and combined, and the viewers can view the 3D stereo image.

The lens array layer 2 is made of a material with good optical characteristics, and the material of the lens array layer 2 is not limited thereto. The lens array layer 2 can include a base 21 and a plurality of lenses 22. The lenses 22 are disposed on a side of the base 21, that is, the lenses 22 are disposed on a side of the base 21 away from the display unit 1. The arrangement and the configuration of the lens array layer 2 are not limited thereto, and the lenses 22 have a focusing function. An un-reconstructed image displayed by the display surface 11 is able to be reconstructed by the lens array layer 2, and be recombined into an integrated image to form a stereo image.

The integrated image display device of the present disclosure allows for 3D stereo images to be viewed from an oblique angle. That is, the viewer does not need to face the display unit 1 from a position directly in front to be able to view the 3D stereo image. In traditional naked-eye 3D stereo image display devices, most of them do not allow for images to be viewed from an oblique angle. Accordingly, the viewer cannot view the 3D stereo images from an oblique angle. In the present disclosure, it is a major feature that 3D stereo images can be viewed from an oblique angle. When the viewers are in the direction of facing the display unit 1 (the zero-order viewing zones), the left and right of the viewers respectively have restricted viewing angles. Once the viewers are beyond the restricted viewing angles, the viewers cannot view the stereo information that corresponds to the corresponding angle. In order to allow for 3D stereo images to be viewed from an oblique angle, the present disclosure adopts an oblique angle display mode to focus the light path in the oblique direction instead of adopting the 0th order (forward) display mode. Accordingly, the viewer can view the stereo image from an oblique angle. The integrated stereo image display device of the present disclosure can also be applied so that the viewer can view the stereo image from a position directly in front of the device.

The display unit 1 can be of any specifications, as long as an algorithm is available. The display unit 1 includes an image processing unit 12, and the images displayed by the display unit 1 need to be calculated by the image processing unit 12. The image processing unit 12 can predict various paths that light will travel along, and then calculate the relative position of the image by the lens array architecture. Since the image processing technology is well known in the art, and will not be reiterated herein.

The lens array layer 2 of the present disclosure has a very significant correlation with the display effect of the image display device. As shown in FIG. 3, the lens array can be arranged in a rectangular manner, so that the lenses 22 in two adjacent columns can be arranged correspondingly opposite to each other. As shown in FIG. 4, the lens array may also be arranged in a hexagonal arrangement, so that the lenses 22 in each two adjacent columns can be arranged in a staggered arrangement. The lens array can also be in other arrangements that can display 3D image information.

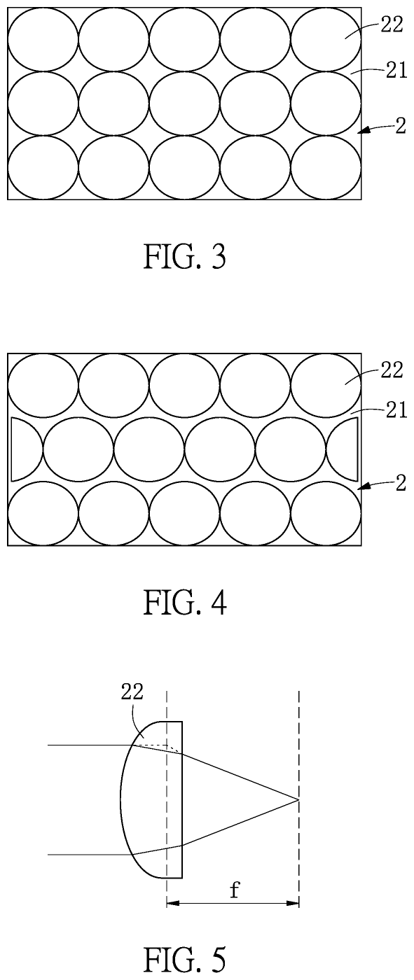

The micro-structures of the lens array layer 2 are lenses with a focusing function. The specification of each of the lenses 22 will determine the lens's focusing ability according to the refractive index n value of the material. Each of the lens 22 transmits light having a wavelength ranging from 300 nm to 1100 nm. As shown in FIG. 5, each of the lens 22 conforms to the Lensmaker's equation: 1/f=(n−1)(1/R1+1/R2), in which R1 and R2 are respective curvature radiuses of two opposite surfaces of the lens, f is a focal length of the lens, and n is a refractive index of the lens. In addition, each of the lenses 22 has a diameter of 10 um to 3 cm (preferably 10 um to 5 mm) so as to be suitable for image display devices with different sizes.

The gradient transmittance mask 3 is disposed adjacent to the display surface 11 of the display unit 1. The gradient transmittance mask 3 can be disposed on a side of the lens array layer 2 that is close to or away from the display unit 1. The gradient transmittance mask 3 can also be directly sprayed on a top or a bottom surface of the lens array layer 2. In the present embodiment, the gradient transmittance mask 3 is disposed on a side of the lens array layer 2 that is close to the display unit 1, that is, the gradient transmittance mask 3 is disposed below the lens array layer 2. The gradient transmittance mask 3 includes a plurality of mask units 31 being disposed on a substrate 32. The mask units 31 respectively correspond to the lenses 22. In the present embodiment, the mask unit 31 is circular and corresponds to the lenses 22, but the shape of the mask unit 31 is not limited thereto. The mask unit 31 can also be in another shape, such as a rectangle or hexagon. The mask unit 31 has a gradual transmittance. The transmittance of the mask unit 31 is increased or decreased from a center of the mask unit 31 to edges of the mask unit 31. In other words, the transmittance of the center of the mask unit 31 is the lowest, and the transmittance of the edges of the mask unit 31 is greatest. In the present embodiment, the mask unit 31 can include a plurality of dots 311. The dots 311 can be made of a semi-transparent or an opaque material. The density of the dots 311 is decreased from the center of the mask unit 31 to the edges of the mask unit 31, so that the transmittance of the mask unit 31 increases from the center to the edges of the mask unit 31.

Manufacturing the gradient transmittance mask 3 can be achieved by inkjet printing or photomask exposure. The gradient transmittance mask 3 can achieve the effect of having different transmittance with different gray levels of images. In addition, the gradient transmittance mask 3 may also have different transmittances by spraying with different materials. A transmittance distribution of the gradient transmittance mask 3 and a pitch of each of the mask units 31 can be adjusted according to the optimal viewing distance for a user. That is, each of the mask units 31 of the gradient transmittance mask 3 at different positions has the different transmittances distributions or the different pitches. The mask units 31 can respectively correspond to the lenses 22, or not. For example, a lens 22 can correspond to a plurality of mask units 31. In addition, the mask units 31 do not necessarily correspond to all the lenses 22. In other words, only a part of the lenses 22 is correspondingly provided with a mask unit 31 to reduce a light intensity, and the other lenses 22 are directly passed through by light. In addition, the mask units 31 are not necessarily completely gradient, and may also have multiple (for example, four, five, and six, etc.) types of different transmittances. The mask units 31 may also be a multi-layer structure. For example, each layer of the mask unit 31 is a concentric circle in a different size and is stacked together to form the gradient transmittance mask 3.

In the present embodiment, the lens 22 is used as an example. When the pixels under one lens 22 are all lit, after imaging, since the amount of light emitted from the edge of the lens 22 is less, the center image of the lens 22 will be brighter than the edge image of the lens 22, and the lenses 22 exhibit a grid-like appearance. The mask units 31 correspond to the lenses 22 respectively. The transmittance of the mask units 31 can be increased from the center to the edges of the mask unit 31. Accordingly, the brightness of the central image of the lens 22 can be reduced, and the mask units 31 have the gradual transmittance so that the brightness of the image can be evenly distributed after imaging without the grid-like appearance as a result of the mask units 31 having different transmittance.

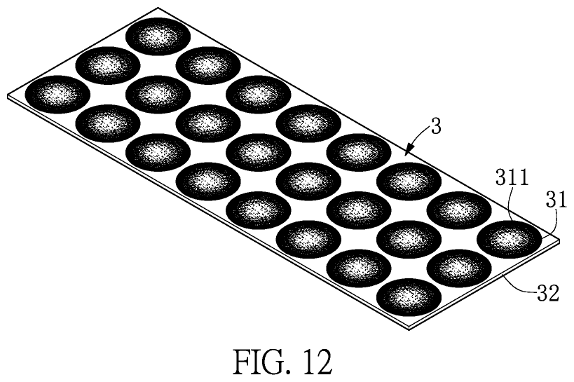

Under certain configurations, the images can be dark in the middle and bright on the side. Therefore, in another embodiment of the present disclosure (as shown in FIG. 12), the transmittance of the mask unit 31 can be decreased from the center to the edge of the mask unit 31. In other words, the transmittance of the center of the mask unit 31 is greatest, and the transmittance of the edge is least.

The present disclosure provides an integrated stereo image display device that can be applied to forward and oblique viewing angles with hardware settings. The integrated stereo image display device can control the direction of light travel of pixels at various positions in the image display device through optical elements. The hardware system of the present disclosure is formed of simple optical elements. The hardware system includes a display unit 1, a lens array layer 2, and a gradient transmittance mask 3. The simple optical elements can be packaged into a kit, and present a real image in stereo space by a designed pixel size, system gap, lens size and focal length with the integrated image principle and a special algorithm through the screen output signal.

In another embodiment of the present disclosure, the pixels of the display unit 1 can also have different brightness by using software. Accordingly, it can be equivalent to the effect of the gradual transmission mask 3.

### Second Embodiment

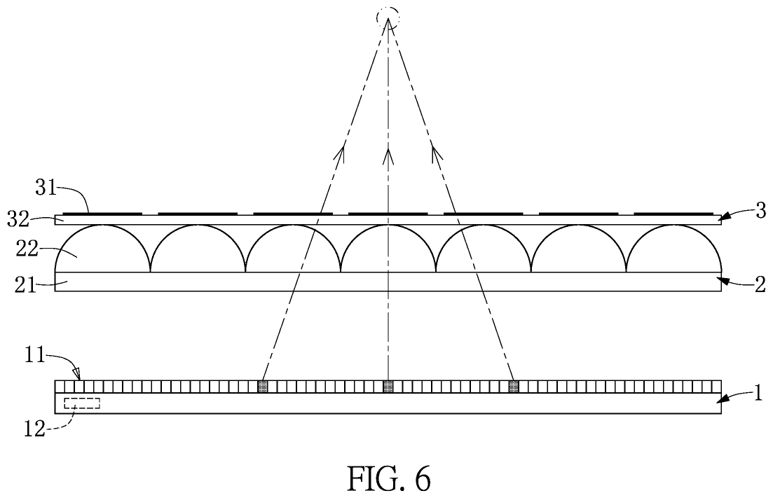

Referring to FIG. 6, the configuration of the image display device of the present embodiment is substantially the same as that of the first embodiment of the present disclosure described above. The only difference is that the gradient transmittance mask 3 is disposed on a side of lens array layer 2 that is away from the display unit, that is, the gradient transmittance mask 3 is disposed above the lens array layer 2. The masking unit 31 of the gradient transmittance mask 3 has a gradual transmittance. The mask units 31 have the gradual transmittance so that the brightness of the image can be evenly distributed after imaging without the grid-like appearance as a result of the mask units 31 having different transmittance.

### Third Embodiment

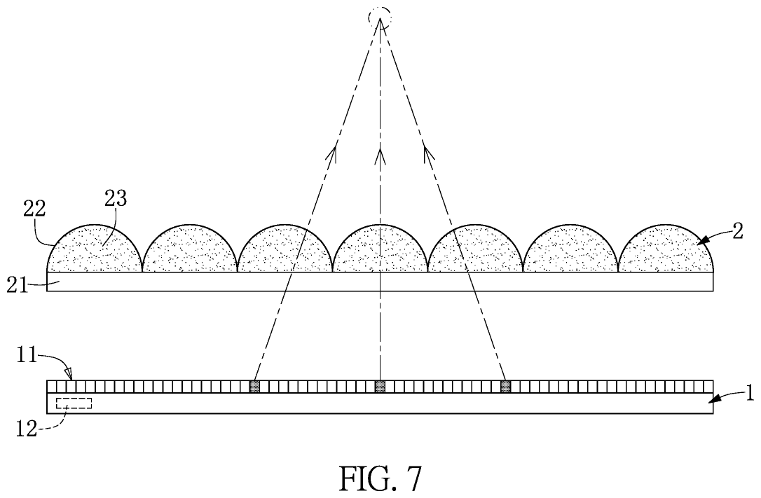

Referring to FIG. 7, the configuration of the image display device of the present embodiment is substantially the same as that of the first embodiment of the present disclosure described above. The only difference is that the gradient transmittance mask 3 in the above embodiment is omitted, and the light absorbing substance 23 is directly added in the materials of the lens 22 so that the transmittance of the lens 22 is inversely proportional to the thickness of the lens 22. Accordingly, the transmittance at the center of the lens 22 is less than the transmittance at the edges of the lens, that is, the center of the lens 22 is thicker and the transmittance of the center of the lens 22 is less. The edge of the lens 22 is thinner and the transmittance of the edge of the lens 22 is greater. The light absorbing substance 23 is able to provide even brightness distribution after imaging.

### Fourth Embodiment

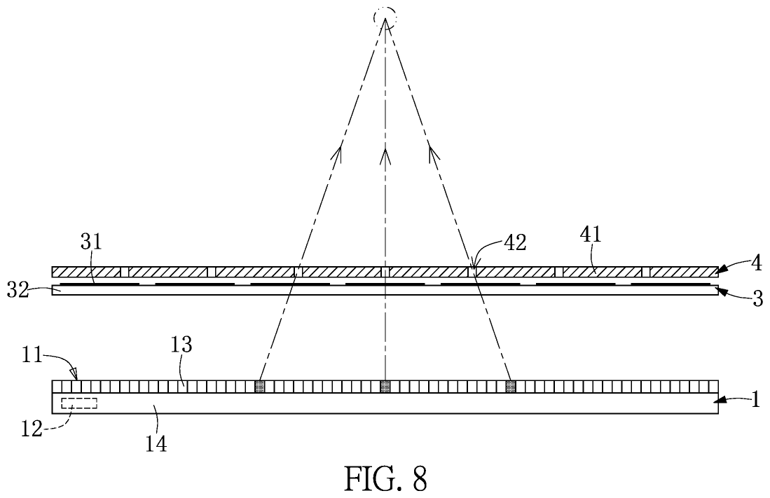

Referring to FIG. 8, in the present embodiment, a pinhole array layer 4 is mainly used to replace the lens array layer 2 in the first embodiment of the present disclosure. The integrated stereo image display device includes a display unit 1, a pinhole array layer 4, and a gradient transmittance mask 3. The display unit 1 can include an LCD panel 13 and a backlight module 14. A display surface 11 is located on the LCD panel 13. The backlight module 14 is close to the LCD panel 13. The backlight module 14 can project a light source and transmit light to the eyes of the viewers after passing light through the LCD panels 13. In the present embodiment, the display unit 1 is a passive light-emitting display device. In another embodiment of the present disclosure, the display unit 1 may also be an active light-emitting display unit, such as an OLED or an LED display unit. In the present embodiment, the gradient transmittance mask 3 is disposed on a side of the pinhole array layer 4 that is close to the display unit 1. Since the configuration of the gradient transmittance mask 3 is the same as that of the first embodiment of the present disclosure, such details will not be reiterated herein.

The pinhole array layer 4 can be disposed adjacent to the display surface 11 of the display unit 1, that is, the pinhole array layer 4 can be disposed above the display unit 1. The pinhole array layer 4 can be arranged in contact with the display surface 11 of the display unit 1, and the pinhole array layer 4 may also be spaced apart from the display surface 11 of the display unit 1, or an intermediate layer can be disposed between the display surface 11 of the display unit 1 and the pinhole array layer 4. The pinhole array layer 4 may also be disposed inside of the display unit 1 or other appropriate locations.

The display unit 1 can be disposed as the bottom layer, and is configured to display the planar images that have not been reproduced by light. The planar image can be redistributed and combined by the pinhole array layer 4 to display the reconstructed 3D stereo image. The pinhole array layer 4 can be disposed as the uppermost layer, and the pinhole array layer 4 is capable of adjusting the light field. The pinhole array layer 4 can modulate the light angle of the stereo image so that the planar images that have not been reorganized can be redistributed and combined, and the viewers can view the 3D stereo image.

The material of the pinhole array layer 4 is not limited in the present disclosure. The pinhole array layer 4 includes a main body 41 and a plurality of pinholes 42, and the main body 41 is made of an opaque material so that the main body 41 is an opaque member. The main body 41 is a plate-shaped body, and the pinholes 42 are preferably circular holes. The pinholes 42 are disposed on the main body 41, and the pinholes 42 can pass through two opposite sides of the main body 41. The distance between each two adjacent pinholes 42 is less than 5 mm, and the diameter of each pinhole 42 is less than 1 mm. The pinholes 42 have a focusing function, and the un-reconstructed images displayed by the display surface 11 can be reorganized by the pinholes 42 with the pinhole principle to be recombined into the integrated image to form a stereo image. The pinholes 42 can be hollow, and a light-transmissible material can be disposed inside of the pinhole 42 so that light can pass through the pinhole 42. The pinhole array layer 4 of the present disclosure has a very significant correlation with the display effect of the image display device. The pinhole array can be arranged in a rectangular or hexagonal arrangement, that is, the pinholes 42 in two adjacent rows can be arranged correspondingly opposite to each other or in a staggered arrangement, and the lens array can also be arranged in other ways. Accordingly, the pinhole array layer 4 and the lens array layer 2 can be used to display 3D image information. The mask units 31 have the gradual transmittance so that the brightness of the image can be evenly distributed after imaging without the grid-like appearance as a result of the mask units 31 having different transmittance.

### Fifth Embodiment

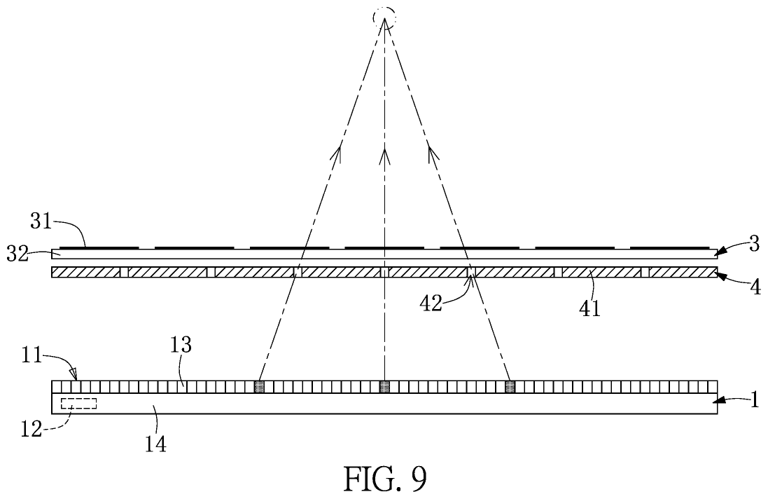

Referring to FIG. 9, the configuration of the image display device of the present embodiment is substantially the same as that of the fourth embodiment of the present disclosure described above. The only difference is that the gradient transmittance mask 3 is disposed on a side of the pinhole array layer 4 that is away from the display unit 1, that is, the gradient transmittance mask 3 is disposed above the pinhole array layer 4. The mask units 31 have the gradual transmittance so that the brightness of the image can be evenly distributed after imaging without the grid-like appearance as a result of the mask units 31 having different transmittance.

### Sixth Embodiment

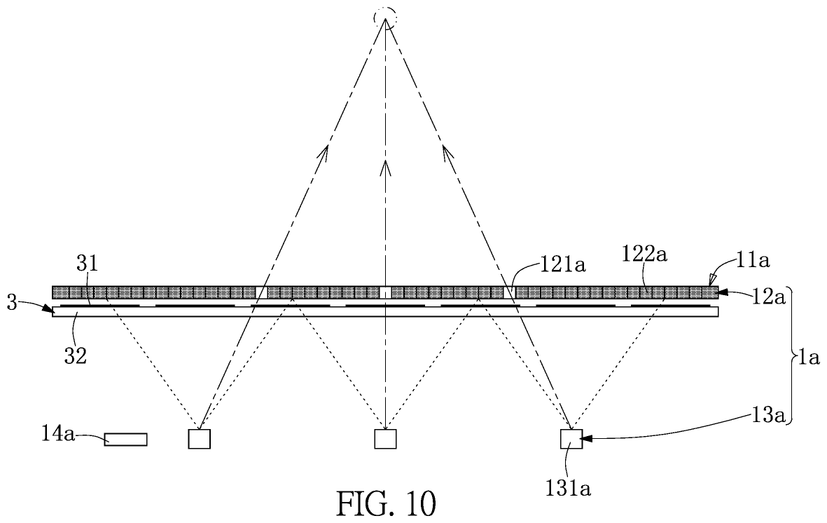

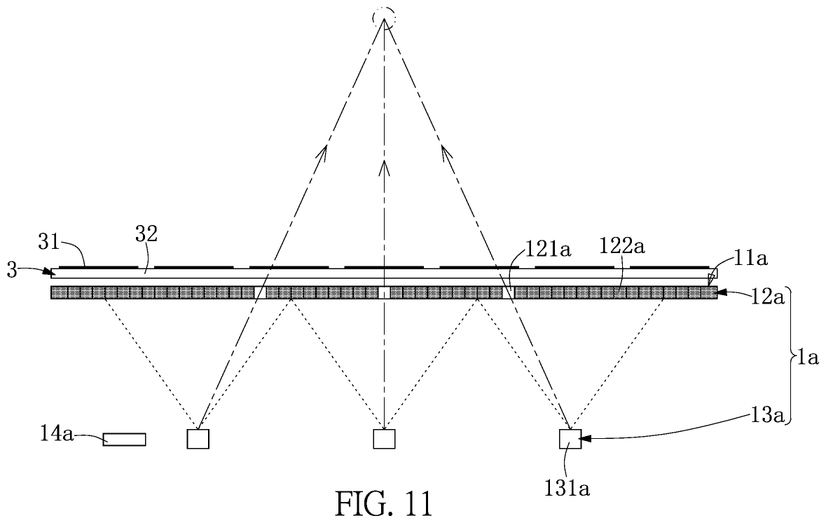

Referring to FIG. 10, in the present embodiment, the integrated stereo image display device includes a display unit 1a and a gradient transmittance mask 3. The display unit 1a includes an LCD panel 12a, a backlight module 13a, and an image processing unit 14a. The LCD panel 12a includes a display surface 11a, and the backlight module 13a can project a light source and transmit light to the eyes of the viewers after passing light through the LCD panels 12a. The light source that needs to be used corresponds to the one mask unit 31 or corresponds to the mask units. In the present embodiment, the LCD panel 12a can turn on the pixels 121a that need to be used and turn off the pixels 122a that need not be used by using software. The backlight module 13a includes a plurality of light sources 131a, and the light sources 131a can be LEDs or OLEDs. The light sources 131a are disposed spaced apart from each other. The light sources 131a can project light and transmit light to the eyes of the viewers after passing light through the LCD panels 12a. The planar images of the display unit 1a can display the reconstructed 3D stereo image by the light sources 131a and the LCD panel.

The gradient transmittance mask 3 can be disposed on a side of the LCD panel 12a that is close to or away from the backlight module 13a. The gradient transmittance mask 3 may also be directly sprayed on the top or bottom surface of the LCD panel 12a. The gradient transmittance mask 3 can also be directly sprayed on the top or bottom surface of the pixels that need to be used. In the present embodiment, the configuration of the gradient transmittance mask 3 is the same as the gradient transmittance mask 3 of the first embodiment of the present disclosure. The gradient transmittance mask 3 is disposed below the LCD panel 12a. The mask units 31 have the gradual transmittance so that the brightness of the image can be evenly distributed after imaging without the grid-like appearance as a result of the mask units 31 having different transmittance.

### Seventh Embodiment

Referring to FIG. 11, the configuration of the image display device of the present embodiment is substantially the same as that of the sixth embodiment of the present disclosure described above. The only difference is that the gradient transmittance mask 3 is disposed on a side of the LCD panel 12a that is away from the backlight module 13a, that is, the gradient transmittance mask 3 is disposed above LCD panel 12a. The mask units 31 have the gradual transmittance so that the brightness of the image can be evenly distributed after imaging without the grid-like appearance as a result of the mask units 31 having different transmittance.

In conclusion, the present disclosure can provide the floating display effect so that the viewers can view the stereo image from an oblique angle and a position directly in front of the device. In addition, the present disclosure provides the gradient transmittance mask including a plurality of mask units. The mask units have a gradient transmittance so that the brightness of the image can be evenly distributed after imaging without the grid-like appearance as a result of the mask units having different transmittance.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An integrated stereo image display device, comprising:
a display unit including a display surface and an image processing unit;
a lens array layer disposed adjacent to the display surface of the display unit, wherein the lens array layer includes a plurality of lenses; and
a gradient transmittance mask including a plurality of mask units, wherein the mask units have a gradient transmittance, and an unstructured image displayed by the display surface is able to be reorganized by the lens array layer, and be recombined into an integrated image to form a stereo image, and wherein the gradient transmittance mask is able to provide even brightness distribution after imaging.

2. The integrated stereo image display device according to claim 1, wherein a transmittance of the mask unit is increased or decreased from a center of the mask unit to edges of the mask unit.

3. The integrated stereo image display device according to claim 1, wherein a lens corresponds to a mask unit or the lens corresponds to the plurality of mask units.

4. The integrated stereo image display device according to claim 1, wherein the gradient transmittance mask is disposed on a side of the lens array layer that is close to or away from the display unit.

5. An integrated stereo image display device, comprising:
a display unit including a display surface and an image processing unit; and
a lens array layer disposed adjacent to a display surface of the display unit, wherein the lens array layer includes a plurality of lenses, and a light absorbing substance is added to a material of the lens so that the transmittance of the lens is inversely proportional to the thickness of the lens with the function of gradual transmission, wherein an unstructured image displayed by the display surface is able to be reorganized by the lens array layer, and be recombined into an integrated image to form a stereo image, and the brightness after imaging is uniformly distributed by a light absorbing substance.

6. An integrated stereo image display device, comprising:
a display unit including a display surface and an image processing unit;
a pinhole array layer disposed adjacent to the display surface of the display unit, wherein the pinhole array layer includes a main body and a plurality of pinholes, and wherein the pinholes are disposed on the main body, and the pinholes pass through two opposite sides of the main body; and
a gradient transmittance mask including a plurality of mask units, wherein the mask units have a gradient transmittance, an unstructured image displayed by the display surface is able to be reorganized by the pinhole array layer and be recombined into an integrated image to form a stereo image, and wherein the gradient transmittance mask is able to evenly distribute an image brightness.

7. The integrated stereo image display device according to claim 6, wherein a transmittance of the mask unit is increased or decreased from a center of the mask unit to edges of the mask unit.

8. The integrated stereo image display device according to claim 6, wherein a pinhole corresponds to a mask unit or corresponds to the plurality of mask units.

9. The integrated stereo image display device according to claim 6, wherein the gradient transmittance mask is disposed on a side of the pinhole array layer that is close to or away from the display unit.

10. An integrated stereo image display device, comprising:
a display unit including a liquid crystal display (LCD) panel, a backlight module, and an image processing unit, wherein the LCD panel includes a display surface, and the LCD panel is able to turn on pixels that need to be used and turn off pixels that do not need to be used, and wherein the backlight module includes a plurality of light sources; and
a gradient transmittance mask including a plurality of mask units, wherein the mask units have gradient transmittance, and an unstructured image displayed by the display surface is able to be reorganized by the light sources and the LCD panel, and be recombined into an integrated image to form a stereo image, and wherein the gradient transmittance mask is able to evenly distribute an image brightness.

11. The integrated stereo image display device according to claim 10, wherein a transmittance of the mask unit is increased or decreased from a center of the mask unit to edges of the mask unit.

12. The integrated stereo image display device according to claim 10, wherein a light source that needs to be used corresponds to a mask unit or corresponds to a plurality of the mask units.

13. The integrated stereo image display device according to claim 10, wherein the gradient transmittance mask is disposed on a side of the LCD panel that is close to or away from the backlight module.
